(19) United States
(12) Patent Application Publication
(10) Pub. No.: US 2006/0157587 A1
(43) Pub. Date: Jul. 20, 2006

(54) Hose spray mixing device

(76) Inventor: Timothy G. Flick, Naples, FL (US)

Correspondence Address: EDWARD M. LIVINGSTON, PA, 963 TRAIL TERRACE DRIVE, NAPLES, FL, 34103, US

(21) Appl. No.: 11/038,858

(22) Filed: Jan. 20, 2005

(51) Int. Cl. B05B 7/26

(52) U.S. Cl. 239/310

(57) ABSTRACT

A hose spray mixing device (17) comprising a mixing nozzle (1), a reservoir (2) for holding a solution (21) and siphon hose (3) to connect the reservoir (2) to the mixing nozzle (1). The reservoir (2) is preferably secured to a location above a water faucet (4). The mixing nozzle (1) is securable to the water faucet (4) on one end and to a garden hose (5) on the other. To use the present invention, the user turns an on/off lever (12) connected to a ball valve (14) on the mixing nozzle (1) or reservoir (2) into an open position to allow solution (21) to flow into the mixing nozzle (1), thereby mixing the solution (21) with the water flowing from the water faucet (4) through the mixing nozzle (1) and the hose (5) for use in cleaning vehicles, fertilizing, pavement cleaning or any other sues requiring solutions to be mixed with water.

### BACKGROUND OF THE INVENTION

This invention relates to spray mixing devices, more particularly, a spray mixing device for use with a garden hose.

Conventionally, people use a hose connected to an outdoor spigot, a bucket, soap and a sponge in order to wash large vehicles, such as cars, boats, motorcycles, etc. outdoors. However, it oftentimes becomes difficult, tiresome and frustrating to wash the object due to the various disadvantages to using the traditional bucket of soapy water.

The first disadvantage relates to time and how one must move quickly in order to wash the object thoroughly. First, a person must mix soap and water together in a bucket to create the cleaning solution for the vehicle. Then, to wash the vehicle, one must first apply clean water to the vehicle, then wash the vehicle with soapy water and then rinse off the soapy water before it dries to the vehicle. Thus, an individual must quickly rinse off the soapy water in order to adequately ensure that the soapy water will not dry on the vehicle.

Another disadvantage to using the conventional bucket of soapy water is that a person must haul the heavy soapy water bucket and garden hose around the vehicle in order to wash the entire vehicle. Anyone who has ever washed a large object outdoors knows that transporting the soapy water bucket and garden hose becomes tiresome and tedious after a short amount of time.

Another disadvantage includes the amount of strength and energy needed to properly wash the vehicle. One must expend a considerable amount of force into scrubbing the vehicle clean; otherwise, dirt will remain on the vehicle.

In addition, other spray mixing devices are designed to attach to the end of the hose, thereby reducing water pressure by about 50%. The latter drastically reduces the distance and intensity with which the water and solution can be sprayed, thereby reducing the effect cleaning capability.

Thus, there exists the need for a spray mixing device that allows an individual to use a conventional garden hose to spray clean water, as well as water mixed with a cleaning solution; quickly and easily with maximum pressure.

The relevant prior art includes the following patents:

| Patent No. | | |
|---|---|---|
| (U.S. unless stated otherwise) | Inventor | Issue/Publication Date |
| 5,353,990 | Williams | 10-11-1994 |
| 1,687,085 | Dow | 10-09-1928 |
| 5,775,593 | Delorme et al. | 07-07-1998 |
| FR 2706787 | Peters | 12-30-1994 |
| 2,302,799 | Peterson | 11-24-1942 |
| 3,807,434 | Rasmussen et al. | 04-30-1974 |
| 2,230,201 | Hermann | 01-28-1941 |
| 6,206,046 | Finley | 03-27-2001 |
| 2003/0132312 | Kelly | 07-17-2003 |

### SUMMARY OF THE INVENTION

The primary object of the present invention is to provide a hose spray mixing device which may be used in conjunction with a standard garden hose.

A further object of the present invention is to provide a hose spray mixing device that is easy to use.

An even further object of the present invention is to provide a hose spray mixing device that is eliminates the need for a person to carry a separate bucket of cleaning solution, such as soapy water.

A further object of the present invention is to provide a hose spray mixing device that utilizes water pressure to mix a cleaning solution with water.

An even further object of the present invention is to provide a hose spray mixing device that utilizes water pressure to clean a vehicle.

An even further object of the present invention is to provide a hose spray mixing device that is securable to a location near a spigot.

Another object of the present invention is to provide a hose spray mixing device that does not reduce the water pressure exerted from the water spigot.

An optional object of the present invention is to provide a hose spray mixing device that can be used to mix and spray other mixtures through a hose, such as liquid fertilizer.

The present invention fulfills the above and other objects by providing a hose spray mixing device comprised of a reservoir in fluid communication to a mixing nozzle moulded in-line between a water spigot and a hose. The reservoir is mountable near a spigot and holds a solution, such as soap, while the mixing nozzle is attachable to a water spigot on one end and a hose on the other.

To use the present invention, the user inserts a cleaning solution into the reservoir. Then, the user turns the water spigot to an open position to allow water to flow through the mixing nozzle. Because the reservoir is connected to the mixing nozzle, cleaning solution is discharged into the mixing nozzle. If the user would like to have a water/solution mixture discharged from the hose, he or she simply turns the lever into an “ON” position to permit water to flow through the mixing nozzle. If the user would like to have only pure water discharged from the hose, he or she simply turns the lever into an “OFF” position, thereby preventing water flow from entering the mixing nozzle.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of the present invention in use;

FIG. 2 is a top view of the mixing nozzle of the present invention;

FIG. 3 is a plan view of the mixing nozzle showing the direction of water flow when in the “OFF” position;

FIG. 4 is a plan view of the mixing nozzle showing the direction of water flow when in the “ON” position; and

FIG. 5 is a perspective view of an alternate embodiment of the mixing nozzle of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | mixing nozzle |
| 2. | reservoir |
| 3. | siphon hose |
| 4. | water faucet |
| 5. | garden hose |
| 6. | mounting bracket |
| 7. | reservoir cap |
| 8. | fastener |
| 9. | end for hose |
| 10. | side section |
| 11. | main body |
| 12. | on/off lever |
| 13. | opening for siphon hose |
| 14. | ball valve |
| 15. | ball valve opening |
| 16. | end for water faucet |
| 17. | hose spray mixing device, generally |
| 18. | first end of side section |
| 19. | second end of side section |
| 20. | optional reservoir on/off lever |
| 21. | solution in reservoir |

With reference to FIG. 1, a side view of the present invention in use is shown. The hose spray mixing device 17 comprises a reservoir 2 connected to an opening for a siphon hose 13 on a side section 10 of the mixing nozzle 1 via a siphon hose 3. The reservoir 2 is preferably secured to a location on the side of a building above a water faucet 4 and is secured to the building using a mounting bracket 6 and fasteners 8. The mixing nozzle 1 is securable to the water faucet 4 on an end for water faucet 16 and is securable to a garden hose 5 on an end for hose 9. The reservoir 2 is sized so as to hold a predetermined amount of solution 21. To insert the solution 21 into the reservoir 2, a user simply unscrews the reservoir cap 7 and empties the solution 21 into the reservoir 2. Although the reservoir cap 7 is preferably threaded so as to twist on and off easily, the reservoir cap 7 may also have other designs, such as a locking design to prevent unauthorized access to the reservoir 2 or a plugging design so as to plug up the opening to the reservoir 2. Additionally, the reservoir 2 may include an optional reservoir on/off lever 20 so as to permit the dispersal of solution into the siphon hose 3.

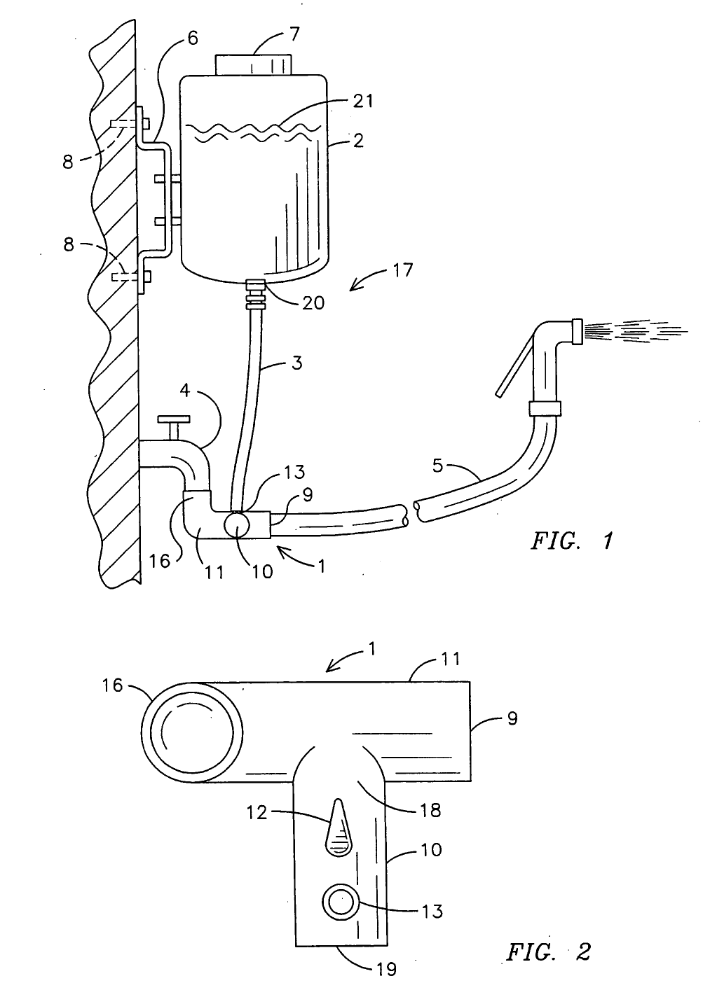

In FIG. 2, a top view of the mixing nozzle 1 of the present invention is shown. The mixing nozzle 1 has a hollow main body 11 portion and a hollow side section 10. The main body 11 has an end for attachment to a water faucet 16 and an end for attachment to a hose 9. Both ends 16 and 9 are threaded so as to easily attach to its respective water faucet and hose. The side section 10 includes an on/off lever 12 and an opening for a siphon hose 13. The side section 10 has a first end 18 and a second end 19 wherein the first end 18 connects the side section 10 to the main body 11.

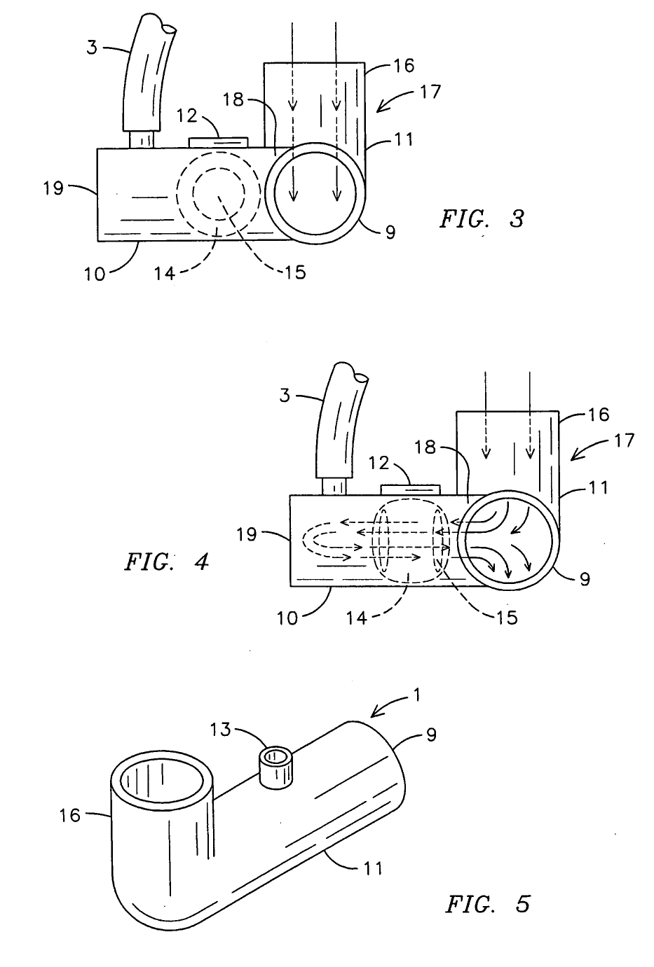

FIG. 3 shows a plan view of the mixing nozzle 1 showing the direction of water flow when in the “OFF” position. The on/off lever 12 allows for the positioning of the ball valve 14 within the side section 10. When the on/off lever 12 is in the “OFF” position, the ball valve opening 15 is positioned such that the cleaning solution in the side section 10 cannot enter the main body 11 and water cannot flow from the main body 11 through the side section 10. The water enters the hose spray mixing device 17 through the end for water faucet 16 on the main body 11 and exits through the end for hose 9, thereby preventing mixing of the cleaning solution with the water from the water faucet 4.

FIG. 4 shows a plan view of the mixing nozzle 1 showing the direction of water flow when in the “ON” position. When the on/off lever 12 is in the “ON” position, the ball valve opening 15 is positioned such that water flows through the side section 10, thereby creating an opening for the water and cleaning solution to mix. Water enters the hose spray mixing device 17 through the end for water faucet 16 on the main body 11 and flows through the side section 10. Because the cleaning solution is siphoned from the reservoir 2 into the side section 10 via the siphoning hose 3, when the water flows through the side section 10, the pressure from the water siphons the cleaning solution from the reservoir 2 into the side section 10 and mixes the cleaning solution with the water. Then, the water/solution mixture exits the side section 10 through the ball valve opening 15 and the water/solution mixture exits the main body 11 through the end for hose 9. Because a user may adjust the on/off lever 12 so that the ball valve opening 15 is fully opened to the side section 10, partially opened to the side section 10 or closed to the side section 10, a user may adjust the amount of cleaning solution he or she uses.

Finally, with reference to FIG. 5, a perspective view of an alternate embodiment of the mixing nozzle 1 of the present invention is shown. The mixing nozzle 1 has a main body 11 on which an opening for a siphon hose 13 is located. To use this embodiment of the mixing nozzle 1, a user attaches the siphon hose 3 connected to a reservoir 2 having an optional reservoir on/off lever 20. The user controls the amount of solution to be used by turning the optional reservoir on/off lever 20 to permit the desired amount of solution to flow into the siphon hose 3 and into the mixing nozzle 1. If the user would like to have only water flowing through the mixing nozzle 1, he or she simply positions the optional reservoir on/off lever 20 to the “OFF” position.

The use of the present invention will allow a person to quickly and easily disperse a mixed cleaning solution through a standard garden hose while still allowing the user to disperse pure water if desired.

Although the present invention is described for use with cleaning solutions, the present invention could also be used with other solutions needing to be mixed with water and dispersed through a hose, such as fertilizers for lawns, chlorine for cleaning algae from one's driveway and so forth.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

1. A hose spray mixing device comprising:
a mixing nozzle having at least two ends of attachment to a spigot and a hose;
a reservoir containing a predetermined solution in fluid communication with the mixing nozzle;
wherein said fluid communication is a siphon hose located between the reservoir and the mixing nozzle and external to said reservoir; and
said mixing nozzle having a means for controlling a flow of the solution from the reservoir located between said at least two ends of attachment.

2. The hose spray mixing device of claim 1 wherein:
said means for controlling a flow of the solution is a ball valve.

3. The hose spray mixing device of claim 1 wherein:
said at least two ends of attachment are threaded.

4. The hose spray mixing device of claim 2 wherein:
said at least two ends of attachment are threaded.

5. (canceled)

6. The hose spray mixing device of claim 1 wherein:
said reservoir is attachable to a predetermined location on a building above a water faucet.

7. The hose spray mixing device of claim 1 wherein:
said reservoir has a means for controlling a flow of the solution from the reservoir.

8. A hose spray mixing device comprising:
a mixing nozzle having at least two ends of attachment to a spigot and a hose;
a reservoir containing a predetermined solution in fluid communication with the mixing nozzle wherein said reservoir has a means for controlling a flow of the solution from the reservoir; and
wherein said fluid communication is a siphon hose located between the reservoir and the mixing nozzle and external to said reservoir;

9. (canceled)

10. The hose spray mixing device of claim 8 wherein:
said at least two ends of attachment are threaded.

11. (canceled)

12. (canceled)

13. The hose spray mixing device of claim 8 wherein:
said reservoir is attachable to a predetermined location on a building above a water faucet.

14. A method of using a hose spray mixing device comprising a mixing nozzle having at least two ends of attachment to a spigot and a hose; a reservoir containing a predetermined solution in fluid communication with the mixing nozzle; wherein said fluid communication is a siphon hose located between the reservoir and the mixing nozzle and external to said reservoir; and said mixing nozzle having a means for controlling a flow of the solution from the reservoir located between said at least two ends of attachment, said method comprising the steps of:
a. attaching said mixing nozzle to a water faucet;
b. fluidly connecting said reservoir to said mixing nozzle;
c. attaching a water hose to said mixing nozzle;
d. opening said means for controlling a flow of the solution; and
e. turning on said water faucet.

15. The method of claim 14 wherein:
said means for controlling a flow of the solution is a ball valve.

16. The method of claim 14, further comprising the step prior to step a of securing said reservoir to a predetermined location adjacent to a water faucet.

17. The method of claim 14, further comprising the step prior to step d of adding a predetermined amount of solution to said reservoir.

18. The method of claim 14 further comprising the step after step e of turning said means for controlling a flow of the solution off.
